(19) United States
(12) Patent Application Publication
(10) Pub. No.: US 2008/0088885 A1
(43) Pub. Date: Apr. 17, 2008

(54) Data Printing System, Data Processing Apparatus and Printer Apparatus

(75) Inventors: Jinichi MIYAZAKI, Kyoto-shi (JP); Hirokazu UEMURA, Gifu-shi (JP)

Correspondence Address: HOGAN & HARTSON L.L.P., 1999 AVENUE OF THE STARS, SUITE 1400, LOS ANGELES, CA, 90067, US

(73) Assignee: MURATA MACHINERY, LTD., Kyoto-shi (JP)

(21) Appl. No.: 11/868,330

(22) Filed: Oct. 5, 2007

(30) Foreign Application Priority Data
Oct. 11, 2006 (JP) 2006-277904
Nov. 16, 2006 (JP) 2006-310286

(51) Int. Cl. H04N 1/00; G08B 21/00; H04N 1/40

(52) U.S. Cl. 358/402; 340/540; 358/405; 358/445

(57) ABSTRACT

A data printing system. In a data processing apparatus, a transmission converting unit converts electronic data into print data, a data transmitting unit transmits converted print data to a printer apparatus, a transmission confirming unit detects alteration of printed electronic data, and an alarm providing unit provides predetermined alarm data to print data to be transmitted when an alteration is detected. In the printer apparatus, a data receiving unit receives print data from the data processing apparatus, a data printing unit prints received print data, an alarm detecting unit detects alarm data provided on received print data, and an alarm reporting unit reports an alteration alarm when alarm data is detected.

### CROSS-REFERENCE TO RELATED APPLICATIONS

This application claims priority under 35 U.S.C 119 to Japanese Patent Application No. 2006-277904, filed on Oct. 11, 2006, and Japanese Patent Application No. 2006-310286, filed on Nov. 16, 2006, which applications are hereby incorporated by reference in their entireties.

### BACKGROUND OF THE INVENTION

1. Field of the Invention

The present invention relates to a data printing system that converts electronic data into print data and transmits the same from a data processing apparatus to a printer apparatus.

2. Description of the Related Art

At present, when electronic data such as document data or image data is printed out by a data processing apparatus, such as a so-called personal computer, the data processing apparatus converts the electronic data into print data using a printer driver, which is installed therein, and outputs the same to the printer apparatus.

When the printer apparatus includes a page printer, the printer driver in the data processing apparatus generates the print data with a Page Description Language (PDL).

The page description language includes an extensible Markup Language Paper Specification (XPS), a Printer Control Language (PCL, registered trademark), a Laser Beam Printer Image Processing System (LIPS, registered trademark), and a PostScript (registered trademark).

The credibility of the electronic data as an original is guaranteed by providing authentication data such as a digital signature to the electronic data. For example, a hash value of the digital data may be stored in the digital signature as authentication data by being encrypted by a secret key of a data creator.

Therefore, as is commonly known, the facts that the creator is authenticated and that the electronic data is not altered are confirmed by creating the hash value from the electronic data, decoding the hash value stored in the digital signature using a public key of the creator, and proving that the hash values match.

Electronic data having authentication data such as a digital signature added thereto is generally important. As is commonly known, when electronic data having authentication data applied thereto is converted into print data and outputted to the printer apparatus by the data processing apparatus, the electronic data is authenticated by the printer apparatus, and then is printed out.

With the data processing apparatus described above, the presence or absence of an alteration of electronic data is confirmed by a predetermined data processing using the digital signature. However, with this printer apparatus, only the authenticated user is able to confirm the presence or absence of the alteration of the electronic data stored in the data processing apparatus.

With the printer apparatus described above, when alteration of the electronic data is detected by an electronic watermark, the electronic data becomes completely black when it is printed out. Then, whether the electronic data is correct or not is determined by the electronic signature and, depending on the result of this determination, the electronic data is sorted to true and correct data or normal data and is printed out.

Therefore, inadequate electronic data is prevented from being printed out as adequate data. However, in both cases, the electronic data is subjected to the authentication process in the printer apparatus. Therefore, specific hardware or software must be installed to the printer apparatus.

### SUMMARY OF THE INVENTION

In view of such circumstances, a first object of the invention is to enable a printer apparatus to report to nearby people that, for example, an ill-intentioned user alters electronic data and outputs the same, or to enable the user to know that the printed out electronic data is altered.

A second object of the invention is to enable a printer apparatus to prevent inadequate electronic data to be printed out as adequate electronic data even with a general structure.

A first data printing system according to the invention includes a data processing apparatus and a printer apparatus. The data processing apparatus includes a transmission converting unit, a data transmitting unit, a transmission confirming unit, and an alarm providing unit. The transmission converting unit converts electronic data to be printed out into print data. The data transmitting unit transmits the converted print data to the printer apparatus. The transmission confirming unit detects an alteration of printed out electronic data. The alarm providing unit provides predetermined alarm data to the print data to be transmitted when the alteration is detected. The printer apparatus includes a data receiving unit, a data printing unit, an alarm detecting unit, and an alarm reporting unit. The data receiving unit receives the print data from the data processing apparatus. The data printing unit prints out the received print data. The alarm detecting unit detects the alarm data provided on the received print data. The alarm reporting unit reports an alteration alarm when the alarm data is detected.

A second data printing system according to the invention includes a data processing apparatus and a printer apparatus. The data processing apparatus includes an electronic transmission unit for transmitting electronic data to be printed out to the printer apparatus. The printer apparatus includes an electronic receiving unit, a data printing unit, a reception confirming unit, and an alarm reporting unit. The electronic receiving unit receives electronic data from the data processing apparatus. The data printing unit prints out the received electronic data. The reception confirming unit detects an alteration of the received electronic data. The alarm reporting unit reports an alteration alarm when the alteration is detected.

A third data printing system according to the invention includes a data processing apparatus and a printer apparatus. The data processing apparatus includes an output operating unit, a transmission converting unit, a data transmitting unit, a transmission confirming unit, and an alarm providing unit. The output operating unit is used for making a selection between direct output and converted output of electronic data. The transmission converting unit converts electronic data to be printed out into print data when the converted output is selected. The data transmitting unit transmits the electronic data to the printer apparatus when the direct output is selected, and transmits the converted print data to the printer apparatus when the converted output is selected. The transmission confirming unit detects an alteration of the electronic data to be printed out when the converted output is selected. The alarm providing unit provides predetermined alarm data on the printed data to be transmitted when the alteration is detected. The printer apparatus includes a data receiving unit, a data printing unit, an alarm detecting unit, a reception confirming unit, and an alarm reporting unit. The data receiving unit selectively receives the electronic data and the print data from the data processing apparatus. The data printing unit prints out the received electronic data or the print data. The alarm detection unit detects the alarm data provided on the received print data. The reception confirming unit detects the alteration of the received electronic data. The alarm reporting unit reports an alteration alarm where the alteration is detected from the received electronic data and where the alarm data is provided on the received print data.

Therefore, in the data printing system of the invention, when electronic data to be transmitted from a data processing apparatus to a printer apparatus and printed out is altered, an alteration alarm is reported from the printer apparatus.

A first data processing apparatus according to the invention includes a transmission converting unit, a data transmitting unit, a transmission confirming unit, and an alarm providing unit. The transmission converting unit converts electronic data to be printed out into print data. The data transmitting unit transmits the converted print data to the printer apparatus. The transmission confirming unit detects an alteration of the electronic data to be printed out. The alarm providing unit provides predetermined alarm data to the print data to be transmitted when the alteration is detected.

A second data processing apparatus according to the invention includes an output operating unit, a transmission converting unit, a data transmitting unit, a transmission confirming unit, and an alarm providing unit. The output operating unit makes a selection between direct output and converted output of electronic data. The transmission converting unit converts the electronic data to be printed out into print data when the converted output is selected. The data transmitting unit transmits the electronic data to the printer apparatus when the direct output is selected, and transmits the converted print data to the printer apparatus when the converted output is selected. The transmission confirming unit detects an alteration of the electronic data to be printed out when the converted output is selected. The alarm providing unit provides predetermined alarm data to the print data to be transmitted when the alteration is detected.

A first printer apparatus according to the invention includes a data receiving unit, a data printing unit, an alarm detecting unit, and an alarm reporting unit. The data receiving unit receives print data from a data processing apparatus. The data printing unit prints out the received print data. The alarm detecting unit detects alarm data provided on the received print data. The alarm reporting unit reports an alteration alarm when the alarm data is detected.

A second printer apparatus according to the invention includes an electronic receiving unit, a data printing unit, a reception confirming unit, and an alarm reporting unit. The electronic receiving unit receives electronic data from a data processing apparatus. The data printing unit prints out the received electronic data. The reception confirming unit detects an alteration of the received electronic data. The alarm reporting unit reposts an alteration alarm when the alteration is detected.

A third printer apparatus according to the invention includes a data receiving unit, a data printing unit, an alarm detecting unit, and an alarm reporting unit. The data receiving unit selectively receives electronic data and print data from a data processing apparatus. The data printing unit prints out the received electronic data or the print data. The alarm detecting unit detects alarm data provided on the received print data. The reception confirming unit detects an alteration of the received electric data. The alarm reporting unit reports an alteration alarm in both cases in which the alteration is detected from the received electronic data and in which the alarm data is provided on the received print data.

The data processing apparatus according to the invention is a processing apparatus and includes a signature confirming unit and a data processing unit. The signature confirming unit confirms whether outputted electronic data is adequate or inadequate on the basis of a digital signature. The data processing unit executes a predetermined processing to the electronic data when it is not determined to be adequate.

Therefore, in the data processing apparatus according to the invention, a predetermined process is executed when the electronic data outputted to the printer apparatus as print data is not confirmed to be adequate by the digital signature. Therefore, for example, printing out the inadequate electronic data as an adequate data is prevented.

Various components according to the invention need only be formed so as to achieve their functions. For example, their functions may be achieved by specific hardware which demonstrates a specific function, a data processing apparatus provided with a predetermined function by a computer program, a predetermined function achieved in the data processing apparatus by the computer program, and combinations thereof.

The various components in the invention do not necessarily have to be individually independent. A plurality of the components may be formed as a single member, a single component may include a plurality of members, a certain component may be a part of another component, or a part of a certain component and a part of another component may be overlapped with each other.

In the data printing system according to the invention, when electronic data sent from the data processing apparatus to the printer apparatus and printed out is altered, an alteration alarm is reported from the printer apparatus. Therefore, for example, the fact that an ill-intentioned user alters the electronic data and prints out the same is reported to nearby people, and the fact that the printed out electronic data is altered is reported to the user.

With the data processing apparatus according to the invention, when electronic data outputted to the printer apparatus as print data is not confirmed to be adequate by a digital signature, a predetermined process is executed. Therefore, for example, even when the printer apparatus of a general structure is used, inadequate electronic data is prevented to be printed out as being adequate.

Other features, elements, processes, steps, characteristics and advantages of the invention will become more apparent from the following detailed description of embodiments of the invention with reference to the attached drawings.

### BRIEF DESCRIPTION OF THE DRAWINGS

FIG. 1 is a block diagram of a data printing system according to a first embodiment of the invention.

FIG. 2 is a flowchart of a process of operation of a data processing apparatus according to the first embodiment.

FIG. 3 is a flowchart of a process of operation of a printer apparatus according to the first embodiment.

FIG. 4 is a front view of a function setting display of a printer controller according to a modification of the first embodiment.

FIG. 5 is a block diagram of a data processing apparatus according to a second embodiment of the invention.

FIG. 6 is a flowchart of a method of data processing in the data processing apparatus according to the second embodiment.

FIG. 7 is a front view of a function setting display of a printer driver according to a modification of the second embodiment.

### DETAILED DESCRIPTION OF EMBODIMENTS OF THE INVENTION

### First Embodiment

While the invention is described with respect to embodiments thereof, it will be apparent to those skilled in the art that the disclosed invention may be modified in numerous ways and may assume many embodiments other than those specifically set out and described herein. Accordingly, the appended claims are intended to cover all modifications of the invention that fall within the true spirit and scope of the invention.

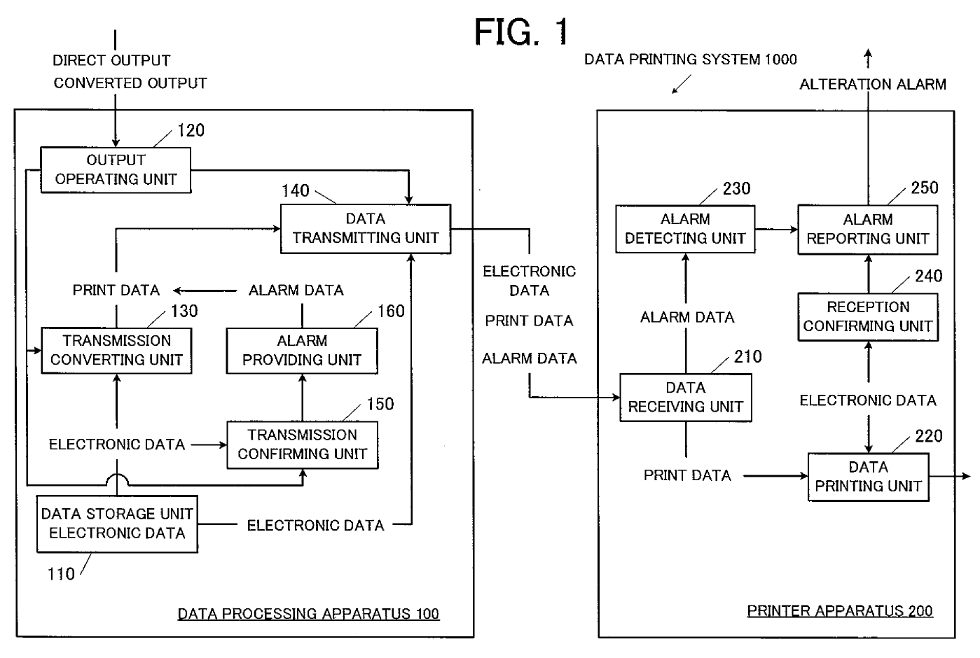

Referring now to the drawings, a first embodiment of the invention is described below. A data printing system 1000 of the first embodiment includes a data processing apparatus 100 and a printer apparatus 200 as illustrated in FIG. 1.

The data processing apparatus 100 includes a data storage unit 110, an output operating unit 120, a transmission converting unit 130, a data transmitting unit 140, a transmission confirming unit 150, and an alarm providing unit 160. The data storage unit 110 stores electronic data. The output operating unit 120 makes a selection between direct output and converted output of the stored electronic data. The transmission converting unit 130 converts electronic data to be printed out into print data when converted output is selected. When direct output is selected, the data transmitting unit 140 transmits the electronic data to the printer apparatus 200 when converted output is selected, the data transmitting unit 140 transmits the converted print data to the printer apparatus 200. When converted output is selected, the transmission confirming unit 150 detects an alteration of the electronic data to be printed out. When an alteration is detected, the alarm providing unit 160 provides predetermined alarm data to the print data to be transmitted.

The printer apparatus 200 includes a data receiving unit 210, a data printing unit 220, an alarm detecting unit 230, a reception confirming unit 240, and an alarm reporting unit 250. The data receiving unit 210 selectively receives electronic data and print data from the data processing apparatus 100. The data printing unit 220 prints out the received electronic or print data. The alarm detecting unit 230 detects alarm data provided on the received print data. The reception confirming unit 240 detects an alteration of the received electronic data. The alarm reporting unit 250 reports an alteration alarm in both cases where the alteration is detected from the received electronic data, and where the alarm data is provided on the received print data.

More specifically, the data processing apparatus 100 includes a computer unit (not illustrated), a storage device, a display device, an input device, and a communication device as hardware (not illustrated) The computer unit includes a Central Processing Unit (CPU), a Read Only Memory (ROM), and a Random Access Memory (RAM). The storage device may be, for example, a Hard Disc Drive (HDD). The display device may be, for example, a Liquid Crystal Display (LCD). The input device may be, for example, a keyboard. The communication device may be, for example, a Local Area Network (LAN) for data communication with the printer apparatus 200 or the like.

The printer apparatus 200 includes a communication device, a computer unit, an electrophotographic mechanism, and a voice output device as hardware (not illustrated). The data processing apparatus 100 and the printer apparatus 200 are totally controlled by the computer unit which executes a computer program for controlling the respective units so that the respective units are logically established as respective functions as illustrated in FIG. 1.

The data processing apparatus 100 includes first and second printer drivers according to the computer program. The first printer driver corresponds to the transmission converting unit 130, the data transmitting unit 140, the transmission confirming unit 150, and the alarm providing unit 160. The first printer driver converts electronic data into print data in a general PDL format such as the PCL or the LIPS, and then transmits the print data to the printer apparatus 200 via the transmission device.

When electronic data to be converted into print data such as the PCL format is in an XPS format, the first printer driver determines the presence or absence of an alteration. When alteration is detected on the electronic data of the XPS format, the first printer driver provides alarm data on the print data to be transmitted to the printer apparatus 200.

The second printer driver corresponds to the data transmitting unit 140, and transmits the electronic data in the XPS format to the printer apparatus 200 by the communication device as print data without converting into the PCL format or the like. Therefore, a function of the input device to make a selection between the first and second printer drivers corresponds to the output operating unit 120.

To output the electronic data in the XPS format as print data without converting into the PCL format or the like means, for example, to output the electronic data in unprocessed XPS format with the provision of data required when printing out, such as the number of copies or printing paper to be used.

The printer apparatus 200 is provided with a printer controller through the computer program. The printer controller corresponds to the data receiving unit 210, the alarm detecting unit 230, and the reception confirming unit 240.

Therefore, when print data is received by the communication device, the print data is converted into image data and is printed out by the electrophotographic mechanism. On the other hand, when electronic data in the XPS format is received by the communication device, the electronic data is converted into image data and is printed out by the electrophotographic mechanism.

However, when print data not in the XPS format, but in the PCL format or the like is received and printed out, the presence or absence of alarm data is determined and, when alarm data is detected, the voice output device outputs an alteration alarm with a voice. When electronic data in the XPS format is received and printed out, the presence or absence of an alteration is determined and, when an alteration is detected, the voice output device outputs an alteration alarm with a voice.

The computer program of the data processing apparatus 100 causes the data processing apparatus 100, for example, to execute processes to receive a selection between direct output and converted output for electronic data, to convert the electronic data to be printed out into print data when converted output is selected, to transmit the electronic data to the printer apparatus 200 when direct output is selected and to transmit the converted print data to the printer apparatus 200 when converted output is selected, to detect an alteration of the electronic data to be printed out when converted output is selected, and to provide predetermined alarm data to the print data to be transmitted when an alteration is detected.

The computer program of the printer apparatus 200 causes the printer apparatus 200 to execute processes of, for example, to selectively receive electronic data and print data from the data processing apparatus 100, to print out the received electronic data or print data, to detect alarm data provided on the received print data, to detect an alteration of the received electronic data, and to report an alteration alarm in both cases where an alteration is detected from the received electronic data and where alarm data is provided on the received print data.

The processes of operation of the data processing apparatus 100 and the printer apparatus 200 in the data printing system 1000 according to the first embodiment are described below. The data processing apparatus 100 has electronic data in various formats registered therein. For example, electronic data in the XPS format is registered.

The electronic data in the XPS format functions as print data of a page printer as it is. Therefore, the data processing apparatus 100 outputs electronic data in the XPS format to the printer apparatus 200 directly as print data.

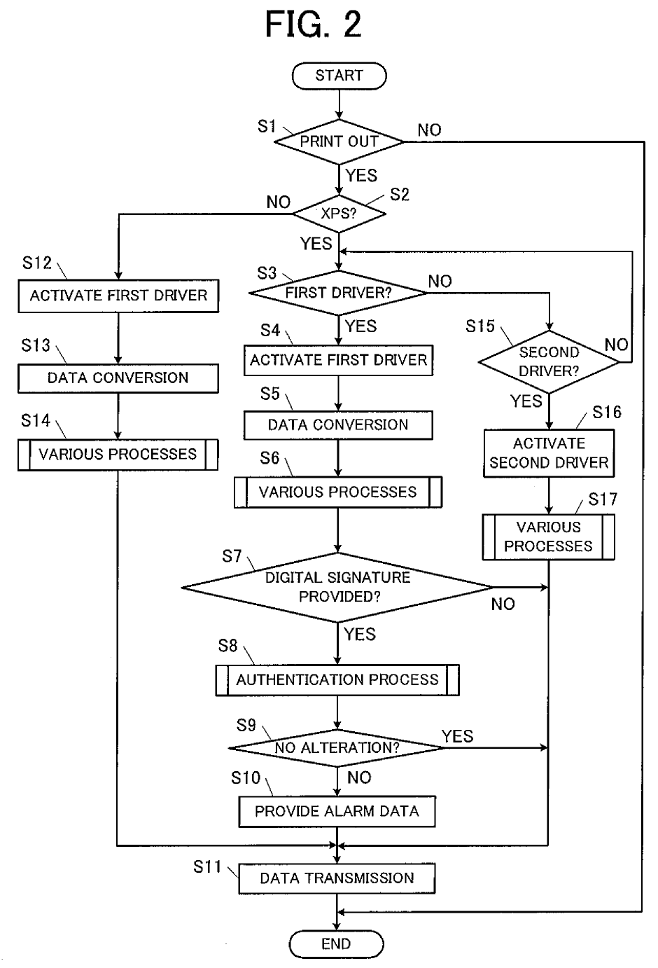

The data processing apparatus 100 provides a digital signature in the XPS format as a default. Therefore, as illustrated in FIG. 2, when a command to print out the electronic data is input (Step S1), the data processing apparatus 100 confirms whether the electronic data is in the XPS format or not (Step S2).

The data processing apparatus 100 is able to output electronic data in the XPS format to the printer apparatus 200 via both the first and second printer drivers.

Accordingly, when the electronic data to be printed out is in the XPS format as described above, whether the first or second printer driver is selected is determined (Steps S3 and S15).

Then, when the second printer driver is selected through the keyboard or the like (Step S15), the second printer driver is activated (Step S16). In this case, for example, various settings such as page setting and/or setting of the number of copies are executed corresponding to an entry through the keyboard (Step S17).

When the various processes by the second printer driver are completed, the electronic data in the XPS format is transmitted to the printer apparatus 200 as print data together with setup data (Step S11).

On the other hand, when the first printer driver is selected through the keyboard or the like (Step S3), the first printer driver is activated (Step S4). Then, the electronic data in the XPS format is converted into print data in the general PDL format such as the PCL by the first printer driver (Step S5). In this case as well, various settings such as page setting and/or setting of the number of copies are executed corresponding to the entry through the keyboard (Step S6).

Whether or not a digital signature is provided on the electronic data in the XPS format is determined (Step S7). When a digital signature is not provided, the authentication process is not executed, and the converted print data is transmitted to the printer apparatus 200 together with the setup data (Step S11).

On the other hand, when a digital signature is provided (Step S7), the authentication process of the electronic data is executed using the digital signature (Step S8). When an alteration is not detected through the authentication process (Step S9), that is, when the result of authentication is normal, the converted print data is transmitted to the printer apparatus 200 together with the setup data without providing predetermined alarm data (Step S11).

On the other hand, when an alteration is detected through the authentication process (Step S9), that is, when the result of authentication is not normal, predetermined alarm data is provided on the print data (Step S10). Provision of the alarm data is executed, for example, by setting a specific flag at a header of the print data and inverting the flag. The print data with the alarm data provided in this manner is transmitted to the printer apparatus 200 together with the setup data (Step S11).

When electronic data to be printed out is not in the XPS format (Step S2), the electronic data cannot be transmitted directly as print data. Therefore, the first printer driver is activated automatically, then, conversion into print data in the PCL format or the like is executed (Steps from S12 to S14), and then the print data after conversion is transmitted to the printer apparatus 200 (Step S11).

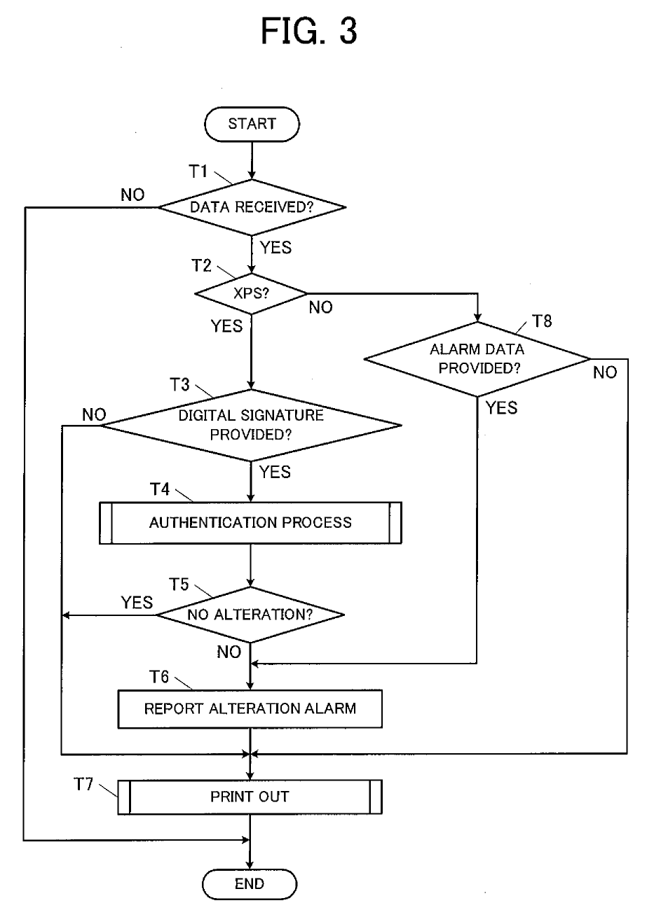

In the printer apparatus 200 which receives print data in the XPS or PCL format or the like from the data processing apparatus 100 (Step T1), whether or not the print data is in the XPS format is confirmed by the printer controller as illustrated in FIG. 3 (Step T2).

When the print data is not in the XPS format, whether or not alarm data is provided is confirmed (Step T8). When alarm data is not provided, the print data in question is converted into image data referring to the setup data and printed out as in the related art (Step T7).

On the other hand, when alarm data is provided on print data which is not in the XPS format but in the PCL format or the like, an alteration alarm such as “this electronic data to be printed out is altered” is outputted with a voice by the voice output device (Step T6) when the print data in question is printed out (Step T7). This voice output may be repeated until a predetermined time period is elapsed.

When the received print data is electronic data in the XPS format (Step T2), whether or not a digital signature is provided is confirmed (Step T3). When a digital signature is not provided, the electronic data in question is converted into image data referring to the setup data and printed out (Step T7).

On the other hand, when a digital signature is provided (Step T3), the authentication process is executed on the electronic data using the digital signature (Step T4). When an alteration is not detected by the authentication process (Step T5), that is, when the result of authentication is normal, the electronic data in question is converted into image data referring to the setup data and printed out (Step T7).

On the other hand, when an alteration is detected through the authentication process (Step T5), that is, when the result of the authentication is not normal, the alteration alarm as shown above is outputted with a voice (Step T6) when the electronic data is printed out (Step T7).

In the data printing system 1000 according to the first embodiment, when electronic data in the XPS format is altered, which can be determined using a digital signature as described above, is printed out, an alteration alarm is outputted with a voice when being printed out.

Therefore, the fact that an ill-intentioned user alters and prints out the electronic data is reported to the people surrounding the apparatus. Therefore, the electronic data is prevented from being printed out inadequately and used.

It is also possible to report to the user the fact that electronic data to be printed out is altered. Therefore, the electronic data which is inadequately altered is prevented from being printed out and used without recognition.

Furthermore, the data processing apparatus 100 in the first embodiment is able to convert electronic data in the XPS format into a general PDL format such as PCL or the like to transmit the same to the printer apparatus 200. When the alteration is detected at the time of conversion in this case, the data processing apparatus 100 is able to provide alarm data to the print data in the general PDL format and transmit the same.

Therefore, even with the printer apparatus which cannot print electronic data in XPS format directly, an alteration of the electronic data may be reported as long as a function to recognize alarm data provided on print data in the general PDL format and output the alteration alarm is provided.

In contrast, when the printer apparatus 200 in the first embodiment receives electronic data in the XPS format, the printer apparatus 200 is able to detect and report an alteration. Therefore, even when the data processing apparatus 100 transmits electronic data in the XPS format without detecting an alteration thereon, the alteration of the electronic data is reported.

In addition, the data processing apparatus 100 is provided with the first and second printer drivers, and hence is able to output electronic data in the XPS format directly and to output the electronic data after having converted it into print data in the PCL format or the like according to the selection of the printer drivers.

Therefore, the convenience of the user is improved. In addition, the printer apparatus 200 is able to report alteration of electronic data irrespective of the selected printer driver.

Furthermore, the function to report alteration of electronic data as described above is achieved by a printer driver which is software installed in the data processing apparatus 100 and a printer controller which is software installed in the printer apparatus 200.

Therefore, it is not necessary to change the hardware in the data processing apparatus 100 and the printer apparatus 200. For example, hardware installed in the related art for informing an error may be used as a voice output device which outputs an alteration alarm with a voice.

The invention is not limited to the first embodiment, and various modifications may be made without departing the scope of the invention. For example, in the first embodiment, a function to detect alteration of electronic data is provided in both of the data processing apparatus 100 and the printer apparatus 200. However, this function may be provided in only one of the data processing apparatus 100 and the printer apparatus 200.

For example, a data processing apparatus (not illustrated) may be provided with the transmission converting unit 130, the data transmitting unit 140, the transmission confirming unit 150, and the alarm providing unit 160. The transmission converting unit 130 converts electronic data to be printed out into print data. The data transmitting unit 140 transmits the converted print data into the printer apparatus 200. The transmission confirming unit 150 detects an alteration of the electronic data to be printed out. The alarm providing unit 160 provides predetermined alarm data to the print data to be transmitted when an alteration is detected. A printer apparatus (not illustrated) does not have a function to print electronic data in the XPS format, and includes the data receiving unit 210, the data printing unit 220, the alarm detecting unit 230, and the alarm reporting unit 250. The data receiving unit 210 receives print data from the data processing apparatus 100. The data printing unit 220 prints out the received print data. The alarm detecting unit 230 detects alarm data provided on the received print data. The alarm reporting unit 250 reports an alteration alarm when the alarm data is detected.

In this case, the printer apparatus is not able to print the electronic data in the XPS format directly, but is able to recognize the alarm data provided on the print data and outputs the alteration alarm.

The data processing apparatus (not illustrated) may not be provided with a function to detect the presence or absence of alteration of electronic data in the XPS format, but provided with an electronic transmitting unit for transmitting electronic data to be printed out to the printer apparatus 200. In this case, the printer apparatus (not illustrated) includes an electronic receiving unit, the data printing unit 220, the reception confirming unit 240, and the alarm reporting unit 250. The electronic receiving unit receives electronic data from the data processing apparatus 100. The data printing unit 220 prints out the received electronic data. The reception confirming unit 240 detects the presence or absence of alteration of the received electronic data using a digital signature included in the received electronic data. The alarm reporting unit 250 reposts an alteration alarm when an alteration is detected in the received electronic data.

In this case, the data processing apparatus transmits the electronic data without detecting the presence or absence of an alteration of the electronic data. However, upon reception of the electronic data in the XPS format, the data processing apparatus detects the presence or absence of alteration and, when an alteration is detected, reports the presence of the alteration.

In addition, in the first embodiment, the printer apparatus 200 outputs an alteration alarm with a voice. However, the data processing apparatus 100 may be provided with a mail transmitting unit (not illustrated) and an alarm transmitting unit (not illustrated). The mail transmitting unit transmits electronic mails. The alarm transmitting unit causes the mail transmitting unit to transmit an electronic mail including an alteration alarm to a predetermined destination when an alteration is detected.

In this case, since an alteration alarm is transmitted to a predetermined destination via an electronic mail, the fact that altered electronic data is printed out may be reported to, for example, an administrator who is in a location apart from the printer apparatus 200.

In the same manner, the printer apparatus 200 is provided with a mail transmitting unit (not illustrated) and an alarm transmitting unit (not illustrated). The mail transmitting unit transmits electronic mails. The alarm transmitting unit causes the mail transmitting unit to transmit an electronic mail including an alteration alarm to a predetermined destination when an alteration is detected.

The printer apparatus 200 may further include a facsimile communication unit (not illustrated) and an alarm transmitting unit (not illustrated). The facsimile communication unit transmits facsimile data. The alarm transmitting unit causes the facsimile transmitting unit to transmit facsimile data including an alteration alarm to a predetermined destination when an alteration is detected.

In this case, the printer apparatus 200 is able to transmit an alteration alarm to a predetermined destination via facsimile. In particular, when the printer apparatus 200 includes Multi Function Peripherals (MFP), the facsimile function is installed as a standard function in many cases. Therefore, the application as described above is effective.

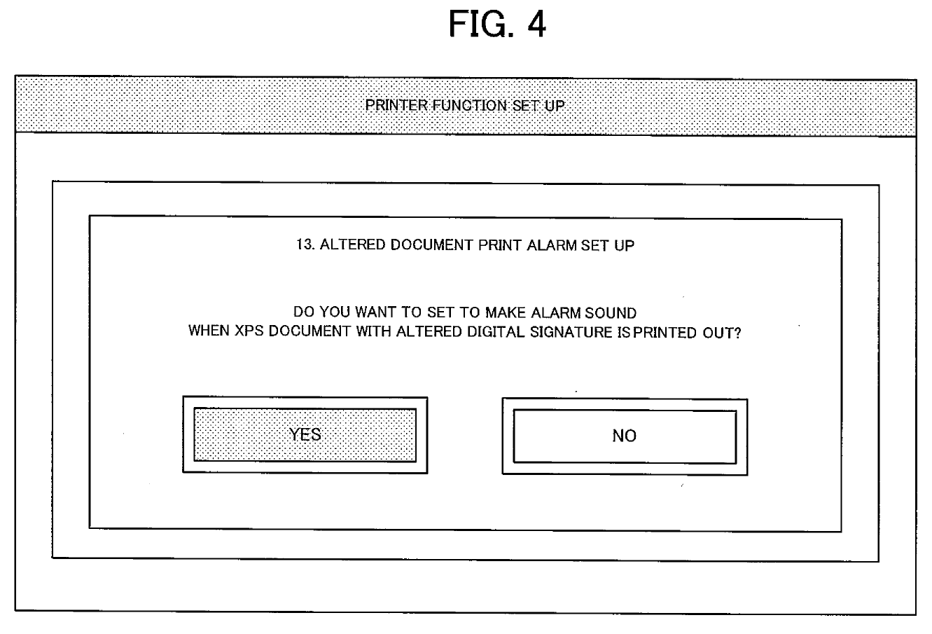

Furthermore, in the embodiment described above, the data processing apparatus 100 and the printer apparatus 200 are provided fixedly with a function to detect an alteration of the electronic data and report an alarm. In other words, an example in which an alteration is detected and an alarm report is executed for all electronic data to be processed has been described. However, as illustrated in FIG. 4, for example, a configuration in which whether an alarm report is executed or not may be set through the function setting display of the printer driver and/or the printer controller may be provided.

However, such a function involves a problem of security. Therefore, a function to set whether an alarm report is executed or not may be protected by a password so that the setting cannot be achieved without entering the password.

In this case, setting of the function to detect an alteration and report an alarm may be changed only by an adequate user such as an administrator, so that lowering of security in printing out of the electronic data is avoided.

In the embodiment described above, the printer driver and the printer controller are described as installed in the data processing apparatus 100 and the printer apparatus 200 as software. However, a configuration in which the printer driver and/or the printer controller composed of hardware are installed in the data processing apparatus and/or the printer apparatus may also be applicable.

Furthermore, in the embodiment described above, a case in which a first printer driver for converting general electronic data or electronic data in the XPS format into general print data in a PDL format such as PCL, and a second printer driver for outputting the electronic data in the XPS format without conversion as print data, are installed in the data processing apparatus 100 has been described.

However, when the printer driver is implemented as a product, various modes are employed. For example, two printer drivers as described above may be integrated into one unit.

The printer driver included in the data printing system 1000 may be divided into a first printer driver for converting general electronic data to general print data, a second printer driver for converting electronic data in the XPS format to general print data, and a third printer driver for outputting electronic data in the XPS format without converting it into general print data.

Furthermore, the printer driver provided in the data printing system 1000 may include a first printer driver for converting general electronic data into general print data and a second printer driver which is able both to output electronic data in the XPS format after having converted into general print data and to output without conversion.

The printer driver provided in the data printing system 1000 may include a first printer driver for converting general electronic data into general print data and outputs electronic data in the XPS format without conversion, and a second printer driver for outputting electronic data in the XPS format after having converted into general print data.

Furthermore, in the embodiment described above, when electronic data whose print out command is supplied is not in the XPS format, the first printer driver is activated automatically, and the electronic data is converted into general print data.

However, when the second printer driver having a function to convert electronic data in the XPS format into general print data and output the same and a function to output the same without converting into general print data does not process general electronic data as described above, it may be configured such that electronic data is processed in the second printer driver after having converted into the XPS format when a print out command of general electronic data other than the XPS format is issued in a state in which the second printer driver is selected.

### Second Embodiment

Referring now to the drawings, a second embodiment of the invention is described below. A data processing apparatus 300 in the second embodiment outputs electronic data provided with a digital signature to a printer apparatus 400 as print data.

Therefore, the data processing apparatus 300 includes a signature confirming unit 310 for confirming whether or not electronic data to be outputted is adequate or inadequate on the basis of a digital signature and a data processing unit 320 for executing a predetermined process on the electronic data when it is not confirmed to be adequate.

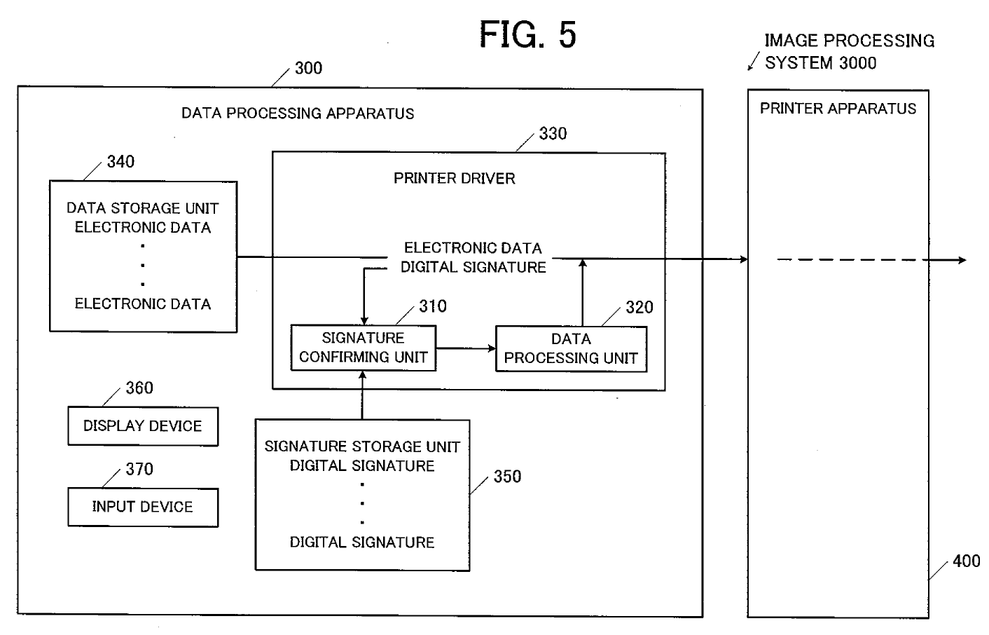

More specifically, as illustrated in FIG. 5, an image processing system 3000 according to the second embodiment includes the data processing apparatus 300 and the printer apparatus 400. The data processing apparatus 300 includes a computer unit (not illustrated), a data storage unit 340, a signature storage unit 350, a display device 360, and an input device 370. The computer unit includes a CPU, a ROM, and a RAM. The data storage unit 340 and the signature storage unit 350 are each composed of a storage area in an HDD. The display device 360 is an LCD or the like. The input device 370 is a keyboard or the like.

The data storage unit 340 stores various electronic data outputted as print data. The signature storage unit 350 stores reliable digital signatures registered therein in advance. The display device 360 displays various data. The input device 370 is operated to enter various data.

The data processing apparatus 300 includes various computer programs installed therein, and various functions are implemented corresponding to the installed computer programs. The data processing apparatus 300 includes a printer driver 330 implemented by one of these computer programs, and the signature confirming unit 310 and the data processing unit 320 are installed in the printer driver 330.

The signature confirming unit 310 confirms whether or not a digital signature is provided on electronic data to be outputted to the printer apparatus 400 as print data. The signature confirming unit 310 also confirms whether or not electronic data to be outputted is altered using a digital signature.

In addition, the signature confirming unit 310 confirms whether or not a digital signature provided on electronic data to be outputted is reliable by confirming whether or not the digital signature provided on the electronic data to be outputted is registered in the signature storage unit 350.

When electronic data is not confirmed to be adequate by the signature confirming unit 310, that is, when the electronic data is determined to be inadequate by the signature confirming unit 310, the data processing unit 320 inserts an alarm message into the electronic data to be outputted as print data.

The computer program as described above causes the data processing apparatus 300, for example, to execute processes of outputting electronic data to the printer apparatus 400 as print data, confirming whether electronic data to be outputted is adequate or inadequate on the basis of a digital signature, and executing a predetermined process on the electronic data when it is not confirmed to be adequate.

A method of processing data by the data processing apparatus 300 in the second embodiment is described below. The data processing apparatus 300 includes electronic data in various formats registered therein, and, for example, electronic data in the XPS format is registered therein.

Electronic data in the XPS format functions as print data of the page printer as is. Therefore, electronic data output by processing apparatus 300 in the XPS format is outputted to the printer apparatus 400 directly as print data.

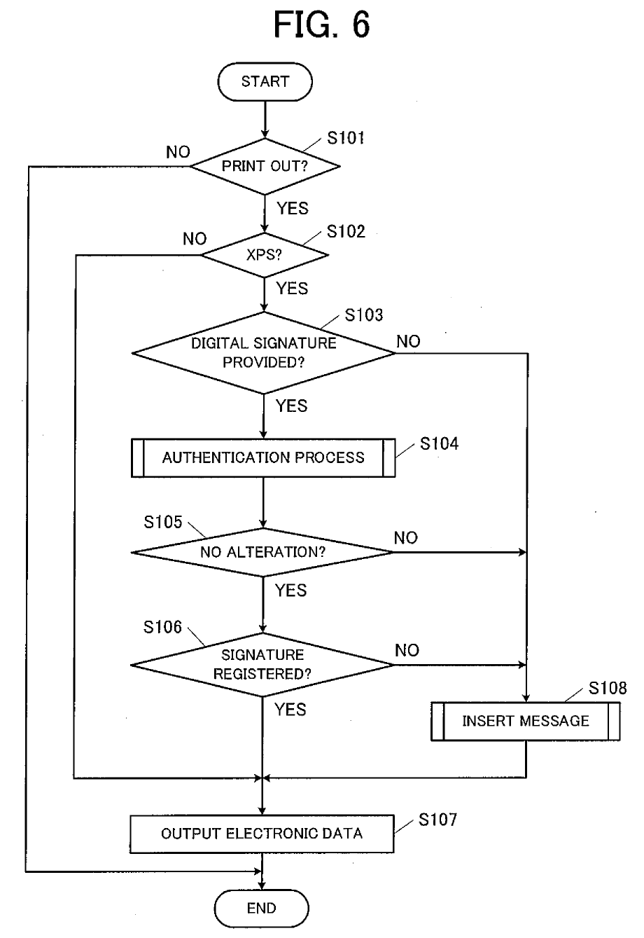

The data processing apparatus 300 has a function to provide a digital signature in the XPS format as a default. Therefore, as illustrated in FIG. 6, when a command to print out electronic data is input (Step S101), the data processing apparatus 300 confirms whether the electronic data is in the XPS format or not (Step S102). When the electronic data is not in the XPS format, the electronic data is outputted directly to the printer apparatus 400, without confirming that a digital signature is provided, and printed (Step S107).

On the other hand, when the electronic data is in the XPS format (Step S102), whether or not a digital signature is provided is confirmed (Step S103). When a digital signature is not provided, an alarm message such as “this electronic data is not provided with a digital signature” or the like is inserted into the electronic data as header data (Step S108).

Since electronic data including the alarm message inserted therein is outputted (transmitted) to the printer apparatus 400 (Step S107), the electronic data having the alarm message inserted as header data is printed out by the printer apparatus 400.

When the provision of a digital signature is confirmed (Step S103), the authentication process of the electronic data is executed with the digital signature (Step S104). When an alteration is detected by the authentication process (Step S105), an alarm message such as “this electronic data is altered since it is created by xxx in dd/mm/yy” is inserted into the electronic data as header data (Step S108).

Since the electronic data including this alarm message inserted therein is outputted (transmitted) to the printer apparatus 400 (Step S107), the printer apparatus 400 prints out the electronic data having the alarm message inserted as header data.

When the authentication process determines that electronic data is not altered (Step S105), it is confirmed whether or not the digital signature is registered as a reliable digital signature (Step S106).

When it is not confirmed, an alarm message such as “This electronic data is created by xxx in dd/mm/yy. However, whether or not the digital signature is reliable is not confirmed” is inserted into the electronic data as header data (Step S108).

Since the electronic data in which this alarm message is inserted is outputted (transmitted) to the printer apparatus 400 (Step S107), the printer apparatus 400 prints out the electronic data including the alarm message as header data.

On the other hand, when the digital signature is confirmed to be reliable (Step S106), the electronic data is directly outputted to the printer apparatus 400 (Step S107). The printer apparatus 400 directly prints out the electronic data in which an alarm message is not inserted.

In the data processing apparatus 300 according to the second embodiment, when a digital signature is not provided on digital data to be outputted to the printer apparatus 400 as print data, an alarm message indicating that a digital signature is not provided is inserted into the electronic data. Therefore, the fact that a digital signature is not provided is reported to a user according to a printed result of the electronic data.

Even when a digital signature is provided on electronic data to be outputted as print data, when an alteration is detected by the authentication process, an alarm message indicating that the alteration is detected is inserted into the electronic data. Therefore, the fact that the electronic data was altered since a time when the digital signature was provided is reported to the user according to a printed result of the electronic data.

Furthermore, even when electronic data to be outputted as print data is confirmed not to have been altered by a digital signature, if the digital signature is not registered as a reliable digital signature, an alarm message indicating that the digital signature is not registered is inserted into the electronic data. Therefore, the fact that the digital signature provided thereto is not reliable is reported to the user according to a printed result of the electronic data.

The process of operation described above is executed by the printer driver 330 of the data processing apparatus 300. Therefore, it is not necessary to install new hardware or software to the printer apparatus 400 in order to implement the process of operation as described above.

In particular, the printer driver 330 is installed in the data processing apparatus 300 through installation of software. Therefore, a function to execute a predetermined process when electronic data is not adequate is achieved easily by the data processing apparatus 300.

In addition, an alarm message as described above is inserted into electronic data as a header. Therefore, the alarm message is provided without affecting the printed image of the electronic data.

When a digital signature is provided to electronic data to be outputted as print data, the fact that the electronic data is not altered is confirmed from the digital signature, and the digital signature is registered as a reliable digital signature, the data processing apparatus 300 outputs (transmits) the electronic data to the printer apparatus 400 without inserting an alarm message. Therefore, the adequate electronic data is printed out without inserting a useless alarm message.

Even when electronic data is not in the XPS format, the electronic data is outputted to the printer apparatus 400. Therefore, an alarm message is not uselessly inserted into the electronic data having a function to provide a digital signature as a default.

The invention is not limited to the second embodiment, and various modifications may be made without departing from the scope of the invention. For example, an example in which a reliable digital signature is registered to the data processing apparatus 300 in advance, and whether or not the digital signature provided on electronic data to be outputted is reliable is confirmed referring to the digital signature, has been described.

However, a configuration may be provided in which a signature guarantee website in which reliable digital signatures are registered exists in the Internet and a data processing apparatus includes an Internet connecting unit for accessing the signature guarantee website.

In this case, the data processing apparatus confirms whether or not a digital signature provided to the electronic data is reliable by confirming whether or not the digital signature provided on the electronic data is registered in the signature guarantee site.

In the data processing apparatus as described above, a digital signature can always be confirmed on a basis of updated registration. On the other hand, the data processing apparatus that confirms the digital signature on electronic data using its own registration is able to confirm a digital signature in a standalone mode.

An adequate method of using a digital guarantee site and a method of using its own registration may be selected depending on various conditions. It is also possible to confirm a digital signature on electronic data using its own registration first and, when confirmation is not successful, to confirm s digital signature on the electronic data using the website.

In the embodiment described above, an example in which an alarm message is inserted into electronic data to be outputted as print data as a header when a confirmation to be adequate is not successful has been described. However, the alarm data may be inserted as footer and/or combined as a watermark.

When a confirmation to be adequate is not achieved, electronic data to be outputted as print data may be converted into a blank state, or into a totally black state.

When a confirmation to be adequate is not achieved, output of electronic data may be stopped. In such cases, the electronic data is not practically printed out, and hence leak of electronic data having high security is effectively prevented.

When a confirmation that electronic data is adequate is not achieved, an alarm may be reported. The alarm may be achieved, for example, by displaying an alarm message on the display device 360.

When a confirmation to be adequate is not achieved, it is also possible to suspend output of electronic data, report an alarm by displaying on the display device 360 in a state in which output of the electronic data is suspended, accept an entry for giving an instruction to release the suspension, and to release the suspension when an instruction to release is entered.

In this case, when the fact that the electronic data is not provided with a digital signature is reported to a user and confirmation is then entered by the user, the electronic data may be printed out. As a matter of course, insertion of an alarm message as described above may be executed on the electronic data to be printed out.

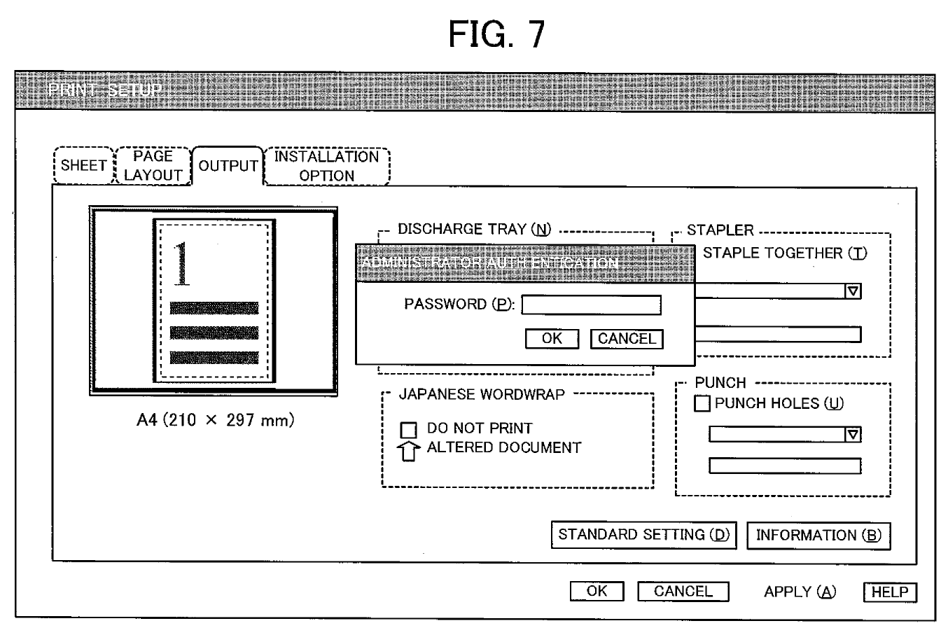

In addition, in the embodiment described above, the functions of the signature confirming unit 310 and the data processing unit 320 are fixed. However, as illustrated in FIG. 7, a configuration may also be provided in which setup of the functions of the signature confirming unit 310 and the data processing unit 320 may be entered by the input device 370 when the function setting display of the printer driver 330 including partly a password input window is displayed on the display device 360 and the correct password is entered.

In this case, the function of the signature confirming unit 310 or the data processing unit 320 may be set up by the user as desired. In addition, since the function can only be set up by an adequate user such as an administrator, lowering of security in printing out electronic data is avoided.

The functions of the signature confirming unit 310 and the data processing unit 320 may be combined variously. For example, a set up configuration such that the presence or absence of a digital signature is confirmed, but the presence or absence of an alteration is not confirmed is also possible.

Furthermore, a configuration may also be provided such that electronic data is not printed out when it is not provided with a digital signature, an alarm message is inserted into the electronic data when it is provided with a digital signature but includes an alteration detected as a header, and an alarm watermark is integrated in the electronic data when alteration is not detected but the digital signature is not reliable.

In the embodiment described above, the printer driver is installed in the data processing apparatus 300 as software. However, a printer driver formed of hardware may alternatively be installed in the data processing apparatus.

While the present invention has been described with respect to embodiments thereof, it will be apparent to those skilled in the art that the invention may be modified in numerous ways and may assume many embodiments other than those specifically set out and described above. Accordingly, the appended claims are intended to cover all modifications that fall within the true spirit and scope of the invention.

What is claimed is:

1. A data printing system comprising:
a data processing apparatus; and
a printer apparatus;
wherein the data processing apparatus includes:
a transmission converting unit for converting electronic data to be printed out into print data;
a data transmitting unit for transmitting the converted print data to the printer apparatus;
a transmission confirming unit for detecting an alteration of printed out electronic data; and
an alarm providing unit for providing predetermined alarm data to the print data to be transmitted when the alteration is detected, and
wherein the printer apparatus includes;
a data receiving unit for receiving the print data from the data processing apparatus;
a data printing unit for printing out the received print data;
an alarm detecting unit for detecting the alarm data provided on the received print data; and
an alarm reporting unit for reporting an alteration alarm when the alarm data is detected.

2. The data printing system according to claim 1,
wherein the data processing apparatus further includes:
a mail transmitting unit for transmitting an electronic mail; and
an alarm transmitting unit for causing the mail transmitting unit to transmit the electronic mail including the alteration alarm to a predetermined destination when the alteration is detected.

3. The data printing system according to claim 1,
wherein the data processing apparatus further includes:
a facsimile communication unit for communicating facsimile data; and
an alarm transmitting unit for causing the facsimile communication unit to transmit the facsimile data including the alteration alarm to a predetermined destination when the alteration is detected.

4. A data printing system comprising:
a data processing apparatus and a printer apparatus,
wherein the data processing apparatus includes:
an output operating unit for making a selection between direct output and converted output of electronic data;
a transmission converting unit for converting electronic data to be printed out into print data when the converted output is selected;
a data transmitting unit for transmitting the electronic data to the printer apparatus when the direct output is selected, and transmitting the converted print data to the printer apparatus when the converted output is selected;
a transmission confirming unit for detecting an alteration of the electronic data to be printed out when the converted output is selected; and
an alarm providing unit for providing predetermined alarm data on the print data to be transmitted when the alteration is detected, and
wherein the printer apparatus includes:
a data receiving unit for selectively receiving the electronic data and the print data from the data processing apparatus;
a data printing unit for printing out the received electronic data or the print data;
an alarm detecting unit for detecting the alarm data provided on the received print data;
a reception confirming unit for detecting the alteration of the received electronic data; and
an alarm reporting unit for reporting an alteration alarm where the alteration is detected from the received electronic data and where the alarm data is provided on the received print data.

5. The data printing system according to claim 4,
wherein the data processing apparatus further includes:
a mail transmitting unit for transmitting an electronic mail; and
an alarm transmitting unit for causing the mail transmitting unit to transmit the electronic mail including the alteration alarm to a predetermined destination when the alteration is detected.

6. The data printing system according to claim 4,
wherein the printer apparatus further includes:
a mail transmitting unit for transmitting an electronic mail; and
an alarm transmitting unit for causing the mail transmitting unit to transmit the electronic mail including the alteration alarm to a predetermined destination when the alteration is detected.

7. The data printing system according to claim 4,
wherein the data processing apparatus further includes:
a facsimile communication unit for communicating facsimile data; and
an alarm transmitting unit for causing the facsimile communication unit to transmit the facsimile data including the alteration alarm to a predetermined destination when the alteration is detected.

8. The data printing system according to claim 4,
wherein the printer apparatus further includes:
a facsimile communication unit for communicating facsimile data; and
an alarm transmitting unit for causing the facsimile communication unit to transmit the facsimile data including the alteration alarm to a predetermined destination when the alteration is detected.

9. A data processing apparatus comprising:
an output operating unit for making a selection between direct output and converted output of electronic data;
a transmission converting unit for converting electronic data to be printed out to print data when the converted output is selected;
a data transmitting unit for transmitting the electronic data to a printer apparatus when the direct output is selected and transmitting the converted print data to the printer apparatus when the converted output is selected;
a transmission confirming unit for detecting an alteration of the electronic data to be printed out when the converted output is selected; and
an alarm providing unit for providing predetermined alarm data to the print data to be transmitted when the alteration is detected.

10. A printer apparatus comprising:
an electronic receiving unit for receiving electronic data from a data processing apparatus;
a data printing unit for printing out the received electronic data;
a reception confirming unit for detecting an alteration of the received electronic data; and
an alarm reporting unit for reposting an alteration alarm when the alteration is detected.

11. A data processing apparatus comprising:
a signature confirming unit for confirming whether outputted electronic data is adequate or inadequate on a basis of a digital signature; and
a data processing unit for executing a predetermined processing to the electronic data when it is not determined to be adequate.

12. The data processing apparatus according to claim 11,
wherein the signature confirming unit confirms whether or not the digital signature is provided on the electronic data to be outputted.

13. The data processing apparatus according to claim 11,
wherein the signature confirming unit confirms whether or not the electronic data to be outputted is altered by the digital signature.

14. The data processing apparatus according to claim 11,
wherein the signature confirming unit confirms whether or not the digital signature provided on the electronic data to be outputted is reliable.

15. The data processing apparatus according to claim 14, further comprising:
a signature storage unit in which a reliable digital signature is registered in advance,
wherein the signature confirming unit confirms whether the digital signature provided on the electronic data to be outputted is registered in the signature storage unit.

16. The data processing apparatus according to claim 14, further comprising:
a signature guarantee Internet website in which reliable digital signatures are registered; and
an Internet connecting unit for accessing the signature guarantee website via the internet,
wherein the signature confirming unit confirms whether or not the digital signature provided on the electronic data to be outputted is registered in the signature guarantee website.

17. The data processing apparatus according to claim 11,
wherein the data processing unit inserts an alarm message in the electronic data to be outputted as print data without having confirmed to be adequate.

18. The data processing apparatus according to claim 11,
wherein the data processing unit integrates a watermark in the electronic data to be outputted as print data without having confirmed to be adequate.

19. The data processing apparatus according to claim 11,
wherein the data processing unit converts the electronic data to be outputted as print data without having confirmed to be adequate into a blank state.

20. The data processing apparatus according to claim 11,
wherein the data processing unit converts the electronic data to be outputted as print data without having confirmed to be adequate into a totally black state.

21. The data processing apparatus according to claim 11,
wherein the data processing unit stops output of the electronic data which is not confirmed to be adequate.

22. The data processing apparatus according to claim 11, further comprising:
an alarm reporting unit for reporting an alarm when the electronic data is not confirmed to be adequate.

23. The data processing apparatus according to claim 11,
wherein the data processing unit further comprises:
an alarm reporting unit for suspending output of the electronic data which is not confirmed to be adequate and reporting an alarm in a state in which the output of the electronic data is suspended;
a release input unit for accepting an entry for giving an instruction to release the suspension; and
an output control unit for releasing the suspension when the instruction to release the suspension is entered.

24. The data processing apparatus according to claim 11, further comprising:
a printer driver including the signature confirming unit and the data processing unit installed therein for outputting the electronic data to a printer apparatus as print data;
a display device for displaying various data such as a function setting display of the printer driver; and
an input device for accepting various entries such as an entry to the function setting display;
wherein the printer driver includes partly a password input window displayed on the function setting display thereof, and does not accept the entry for setting a function to at least one of the signature confirming unit and the data processing unit when the password is not entered into the input window.
